(19) United States
(12) Patent Application Publication
(10) Pub. No.: US 2025/0268230 A1
(43) Pub. Date: Aug. 28, 2025

(54) Protective Face Mask for Animals

(71) Applicant: Carrie Voltz, Cary, IL (US)

(72) Inventor: Carrie Voltz, Cary, IL (US)

(21) Appl. No.: 19/057,568

(22) Filed: Feb. 19, 2025

Related U.S. Application Data
(60) Provisional application No. 63/557,668, filed on Feb. 26, 2024.

(51) Int. Cl. A01K 13/00

(52) U.S. Cl. CPC A01K 13/006

(57) ABSTRACT

A multi-layered, modular protective mask designed for a wide range of animals, providing comprehensive protection against environmental hazards while promoting comfort and addressing health needs. The mask includes a lightweight outer layer made from durable materials to shield against UV rays, insects, and debris. An interchangeable inner layer provides thermal insulation and, optionally, therapeutic benefits, utilizing materials infused with substances like CBD oil for healing and comfort. Ear coverings, which can be optionally detachable offer additional protection tailored to various animal anatomies. The mask and its components are adaptable to different species and customizable for visibility, comfort, size and therapeutic needs.

### REFERENCE TO RELATED APPLICATION

This application is based on and claims priority of provisional patent application Ser. No. 63/557,668 filed Feb. 26, 2024.

### TECHNICAL FIELD

This disclosure relates to the field of equine protective wear, in particular, masks designed for horses to provide warmth and protection in cold or inclement weather.

### BACKGROUND

In the realm of equestrian care and management, the well-being, safety and comfort of horses during various weather conditions is a paramount concern for owners, caregivers, and professionals within the industry. With the advent of technology and textiles, a significant focus has been directed toward the development and enhancement of equine apparel that not only provides protection from environmental elements but also ensures the health, safety, and performance of these animals. The equestrian consumer market has witnessed the introduction of a variety of masks designed to address distinct needs, including fly masks to protect against insects, anti-UV masks for sun protection, and therapeutic masks aimed at promoting healing and relaxation.

Materials providing warmth, integral to the design of winter equine blanket wear, have evolved significantly. Traditional materials such as wool and fleece have been staples due to their natural insulation properties. Advances in textile technology have introduced synthetic fibers that offer superior warmth-to-weight ratios, moisture-wicking capabilities, and durability. Materials such as Thinsulate, Polar Fleece, and neoprene are commonly utilized in equine apparel for their ability to retain heat while ensuring breathability and comfort. Additionally, innovations in fabric technology have led to the development of materials that reflect the horse's own body heat, such as ceramic-infused textiles, providing enhanced warmth and therapeutic benefits.

The significance of ear protection in equine apparel cannot be understated. Horses' ears are highly sensitive and susceptible to cold, moisture, and noise, which can affect their comfort and potentially their health. Products in the market have sought to address bothersome insects and sounds (e.g., noise) concerns through designs that offer mesh and soundproofing materials, respectively. The ability to incorporate weather-protective, breathable, removable ear coverings in equine masks is an unmet need and requires a nuanced understanding of equine anatomy and the challenges posed by different weather conditions. These feature allow for adaptability and customization based on immediate environmental factors and the specific needs of the horse.

Moreover, the development of equestrian masks that address a combination of concerns-ranging from weather protection to sensory sensitivities-highlights a comprehensive approach to equine care. The intersection of material science, veterinary medicine, and equine ergonomics has facilitated the creation of products that not only enhance the comfort and safety of horses but also contribute to their overall well-being.

Despite the variety of masks available in the equestrian consumer market, there remains a distinct gap in offerings specifically tailored to the needs of horses during cold, windy and/or wet weather conditions. While current products address aspects such as insect protection, UV shielding, and therapeutic benefits, few provide a comprehensive solution that encompasses warmth, breathability, and ear protection against cold, moisture, and sound in a single design. The diversity of warmth materials and the nuanced requirements for horse comfort and health during colder climates highlight a clear unmet need. There is a pressing demand for an innovative equine mask that integrates advanced materials and a versatile design to offer a holistic solution to these challenges. Such an invention would not only elevate the standard of equine care in adverse weather but also represent a significant advancement in the field of equestrian apparel, fulfilling a critical gap in the market and setting a new benchmark for horse comfort and protection.

### SUMMARY

This application relates to a novel equine mask designed to offer comprehensive protection and comfort to horses in cold, windy and/or wet weather conditions. The mask incorporates an inner layer made from one or more of a variety of materials known for their thermal properties, including, but not limited to wool, fleece, Thinsulate, Polar Fleece, and neoprene, as well as advanced textiles that reflect the horse's own body heat back towards the skin, providing enhanced warmth without compromising on weight or bulk.

A key feature of the mask is its inclusion of breathable, optionally-removable portions specifically designed to cover the horse's ears. These portions are crafted from materials that ensure warmth, moisture resistance, and sound dampening, addressing the need for ear protection against cold, windy and wet conditions, while also allowing for customization based on environmental conditions and the individual horse's needs. The removable nature of these ear covers facilitates easy cleaning, adjustment, and replacement, thereby extending the usable life of the mask and enhancing its versatility.

Moreover, the mask is designed with the comfort and anatomical structure of the horse in mind, ensuring a snug yet comfortable fit that prevents slippage and irritation. The choice of materials and the design of the mask also prioritize breathability, ensuring that while the horse is protected from the cold, air circulation is maintained to prevent overheating and moisture accumulation, which could lead to discomfort or skin issues.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting. In case of conflict with terms used in the art, the present specification, including definitions, will control.

The foregoing summary is illustrative only and is not intended to be in any way limiting. In addition to the illustrative aspects, embodiments, and features described above, further aspects, embodiments, and features will become apparent by reference to the drawings and the following detailed description and claims.

### BRIEF DESCRIPTION OF DRAWINGS

The present embodiments are illustrated by way of the figures of the accompanying drawings, which may not necessarily be to scale, in which like references indicate similar elements, and in which:

FIG. 1 illustrates a protective face mask on a horse, according to one embodiment;

FIG. 2 illustrates a protective face mask on a horse, according to a second embodiment having an opening for the horse's eye;

FIG. 3 illustrates a protective face mask on a horse, according to a third embodiment;

FIG. 4 illustrates a protective face mask on a horse, according to a fourth embodiment;

FIG. 5 illustrates a protective face mask on a horse, according to a fifth embodiment;

FIG. 6 illustrates a protective face mask on a horse, according to a sixth embodiment in which the face mask has an extended portion over a portion of the horse's neck;

FIG. 7 illustrates a protective face mask on a horse, according to a seventh embodiment in which the eyes are covered;

FIG. 8 illustrates a protective face mask on a horse, according to an eighth embodiment in a bridle is attached to the face mask. and

FIG. 9 illustrates a protective face mask on a horse, according to a ninth embodiment in which a bridle is attached to the face mask.

### DETAILED DESCRIPTION OF ILLUSTRATIVE EMBODIMENTS

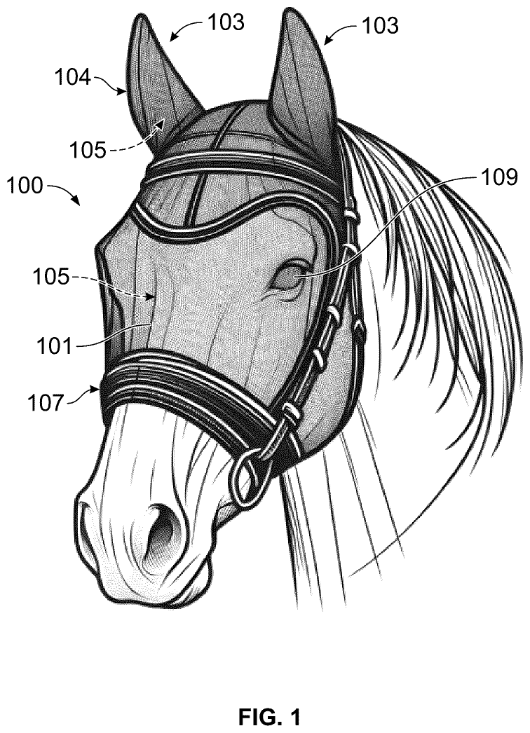

Referring to FIG. 1, this disclosure relates to advanced and versatile animal protective mask, specifically a multi-layered mask (100) providing comprehensive protection from a variety of elements and is adaptable for a wide array of animals. The mask (100) is described herein with respect to equine use but is applicable and adaptable to cater to other animals such as, but not limited to donkeys, mules, ponies and zebras; the mask may also extend to other domesticated and exotic species including llamas, alpacas, goats, sheep, dogs, and others. The mask (100) provides improvement in animal welfare and management, addressing the varied needs and challenges encountered by animal owners, caretakers, veterinarians, and trainers.

In this embodiment, the mask (100) includes ear coverings (103), that are optionally removable from the rest of the mask (100) in modular form and designed to accommodate animals with varying anatomical features and protection requirements. The mask (100), ear coverings (103) and any other accessories in this or other embodiments can be customized to suit the size, shape and other anatomical features of the animal. While the present disclosure focuses on equine use, the ear coverings (103) are adaptable for use with other animals such as mules, llamas, alpacas, goats, dogs, and other animals. The ear coverings (103) include an outer layer (104) exposed to the outside environment, and inner layer (105) (identified with dashed line in FIG. 1) configured to be between the outer layer (104) and the anatomy of the animal's ear. The ear coverings (103) can be interchangeable and chosen to protect the animal from one or more of insects, sound or inclement weather, including cold, windy or rainy conditions.

The outer layer (104) of the ear coverings (103) can be formed of premium materials such as breathable mesh, soft fleece, waterproof nylon, synthetic insulation materials of varied gram weights, durable leather or any other adequate material to provide protection against flies, insects, wind, and other environmental factors while ensuring optimal comfort and mobility. Additionally, for animals with sensitive ears or prone to infections, the coverings (103) may feature antimicrobial properties or soft, hypoallergenic linings to prevent irritation and promote ear health, thus enhancing the overall well-being of the animal.

In this embodiment, the main body (101) of the mask (100), serves as a defense against a plethora of environmental conditions and hazards to the animal. The main body (101) can be formed from the same material of the outer layer (104) of the ear coverings (103), e.g., mesh fabrics, durable nylon blends, moisture-wicking polyester, sustainable organic cotton, or eco-friendly bamboo fibers, and generally provides a lightweight yet robust barrier against insects, dust, debris, and harmful ultraviolet (UV) radiation. Also the main body (101) may have an inner layer (105) (identified with dashed line in FIG. 1) configured to be between the main body (101) and the animal's face. In one embodiment, the incorporation of reflective strips or patterns (not shown) enhances visibility during low-light conditions, ensuring safety during dusk or nighttime activities. The main body (101) can be designed with considerations for animal comfort, for example, being formed from hypoallergenic options such as organic hemp, silk, or natural rubber to minimize skin irritation and allergies, thus promoting prolonged wear without discomfort. Although the mask (100) is shown with a halter (107), the halter (107) it should be realized that the halter (107) is not a part of the mask (100). However, it can be in an alternate embodiment affixed to the mask (100). The main body (101) in FIG. 1 has eye coverings (109) the protect the animal's eyes. However in alternate embodiments the main body (101) may have openings for the animal to easily see through.

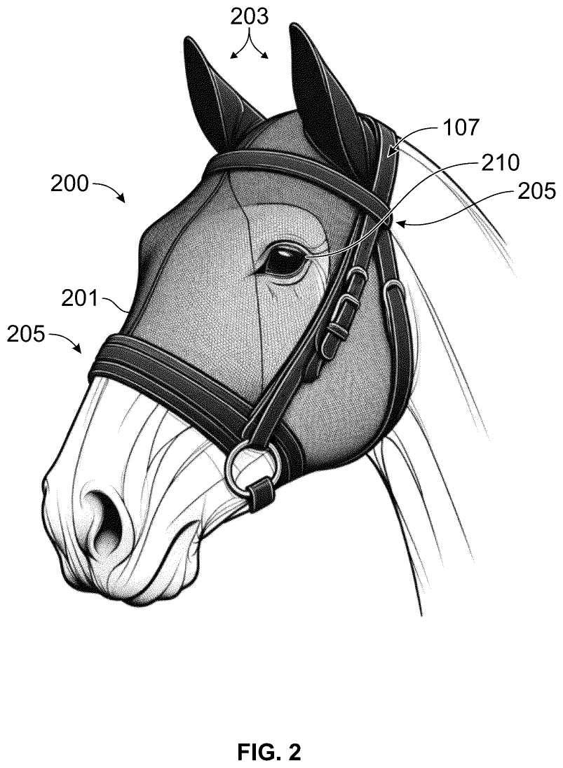

FIG. 2 illustrates a second embodiment of a mask (200) similar to the first mask embodiment (100). In this embodiment, the ear coverings (203) are formed of a firm material such leather or, in general, a material that provides protection from weather such as wind and rain. The ear coverings in this embodiment may also protect the animal from loud sounds which are known to spook animals such as horses in particular. In this embodiment, the ear coverings (203) are removable from the remainder of the mask (200). The main body (201) of the mask can include a lightweight mesh material similar to the main mask body (101) of the first mask embodiment (100). In this embodiment, the mask includes an assembly (205) of straps that are configured to secure the mask to the horse's head, similar to a halter, with the lightweight mesh material running between straps and attachment points as illustrated. In this embodiment the mask (200) has openings (210) in front of the animal's eyes.

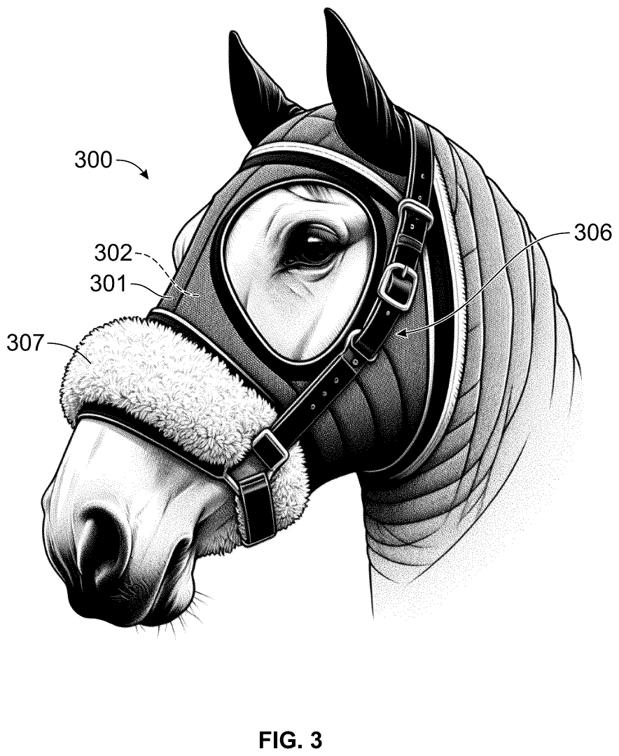

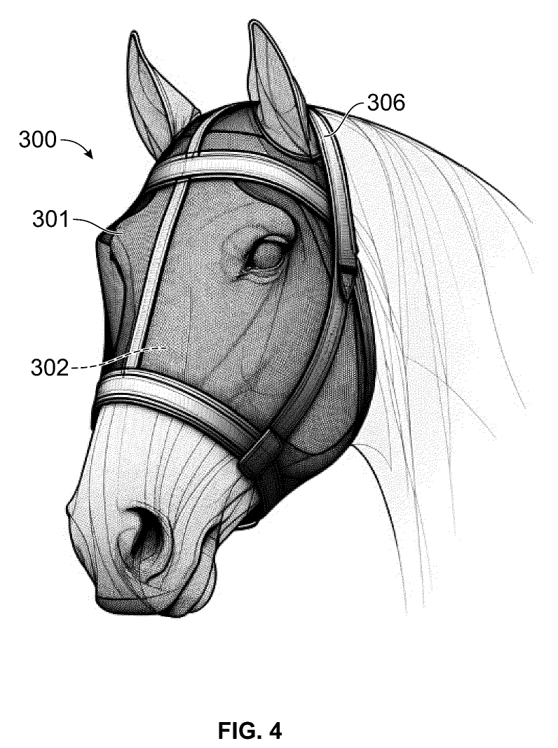

Referring now to FIGS. 3 and 4, in this embodiment, the mask (300) includes an interchangeable inner layer (shown in dotted line 302) throughout the mask that confronts the outer layer (301). The inner layer provides insulation, warmth, and, optionally, therapeutic benefits tailored to the specific needs of animals in various climates and seasons. The inner layer can be formed from a diverse range of materials, including, but not limited to plush fleece, insulating wool, alpaca wool, advanced thermal fabrics, or moisture-wicking microfiber blends, ensuring optimal temperature regulation and comfort. To address specific therapeutic needs, the inner layer may be infused with substances such as CBD oil, aloe vera, or herbal extracts, offering soothing and healing properties to animals with skin conditions or injuries. Furthermore, the inclusion of optional breathable membranes, cooling gel inserts, or moisture-wicking fabrics may enhance comfort and prevent overheating in animals prone to excessive sweating, thus ensuring optimal performance and well-being in diverse environmental conditions.

In this embodiment, to ensure a secure and comfortable fit for animals of various sizes and breeds, the mask (300) incorporates adjustable straps (306), designed to cater to different head shapes, sizes, uses and preferences. It should be understood that other strap configurations can be used as alternatives to that shown in FIG. 3. These straps (306) can be customized to suit miniature horses, ponies, dogs, goats, sheep, and other animals, providing flexibility and ease of use. Alternative fastening mechanisms such as Velcro closures, buckle systems, magnetic clasps, or snap buttons offer further customization options to accommodate different species and user preferences. Moreover, the inclusion of padded straps (307), adjustable chin straps (306), or elastic bands enhances comfort and stability, ensuring a snug fit and minimizing movement during rigorous activities or outdoor excursions.

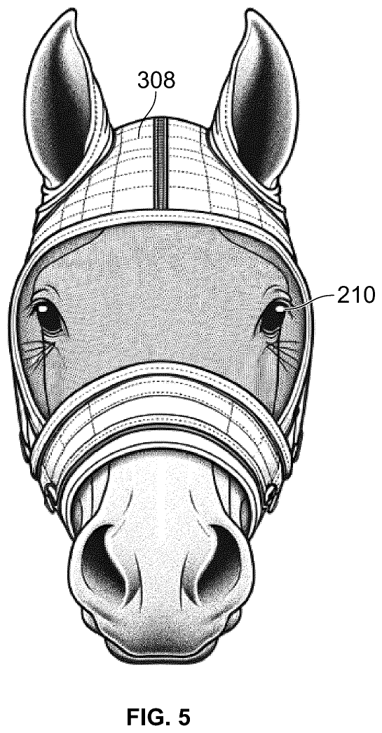

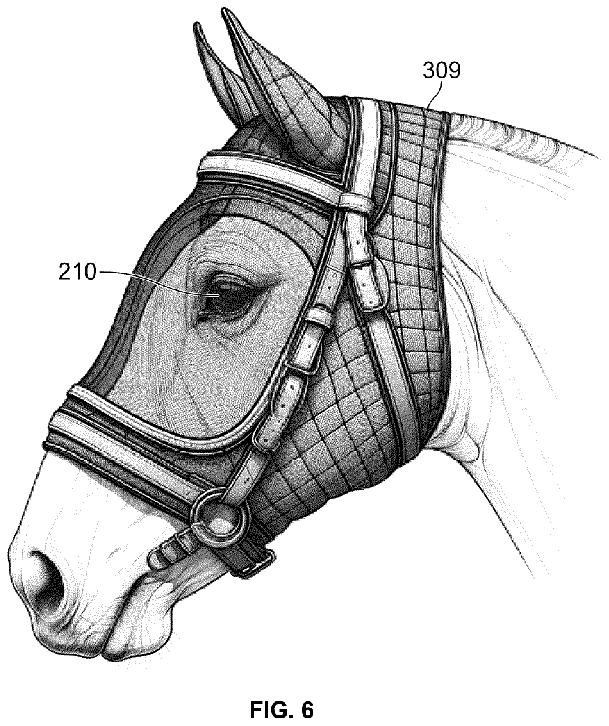

FIGS. 5-9 illustrate different embodiments of masks of the type described herein, to exemplify different arrangements of parts, covering of different parts of the horse's anatomy and other features that can be adjusted or modified for varied purposes. For example, in FIG. 5 the mask (300) has an insulated top portion (308) covering the animal's head. Another example is seen in FIG. 6 where the mask (300) can be extended to a neck area (309); the openings for the horse's eyes may be larger or smaller depending on use of the mask, tolerance of the horse, owner/rider preference or other factors.

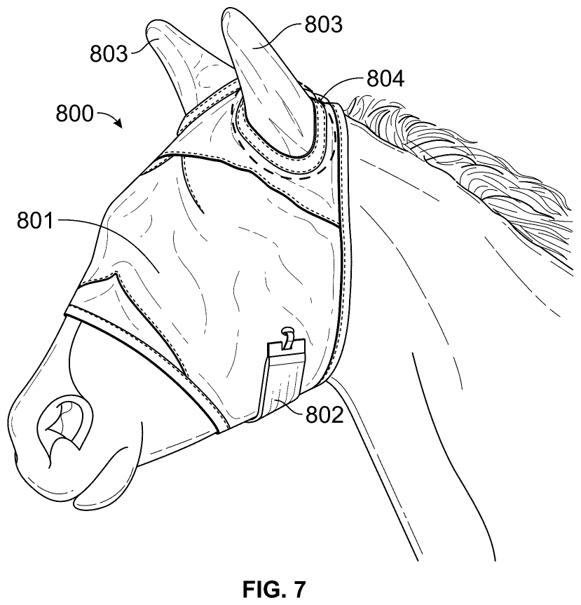

FIG. 7 is an equine face mask with integrated ear protection (hereinafter ‘face mask’ 800), according to one embodiment. In this embodiment, the face mask 800 includes a main mask body 801 that covers the forelock, eyes, forehead, bridge of the nose, jaw and occiput as shown. The main mask body 801 is secured to the horse by way of an adjustable strap 802 that extends from the right side of the main mask body 801 to the left side of the main mask body 801 as illustrated.

In this embodiment, the face mask 800 includes two removable ear covers 803. Each ear cover 803 can be attached to or removed from the main mask body 801 by way of a connector 804. The ear covers 803 may be of varying type, as described in greater detail herein, and may be chosen according to factors such as weather, noise, pollution, dust, wind or other conditions.

For example, an ear cover 803 providing protection from cold weather can include an outer liner and an inner liner attached to the outer liner. Various materials can comprise the inner and outer liner of the ear cover 803 or can be used independently. For example, Gore-Tex® material can provide breathability and wind protection for the ears, which may be sufficient for dry, very cold weather applications. On the other hand, an outer layer of a thin material such as nylon and an inner layer of fleece material may provide adequate protection for moderately cold weather or in conjunction with sound protection.

Other materials commonly used to provide protection and insulation can be used. For example, thermal insulation, often made from synthetic fibers like polyester or natural materials like down feathers can be used for inner liner materials, which can aid in retaining body heat and keeping the ears and face warm in cold conditions. Materials that are both windproof and waterproof, such as leather, Gore-Tex® or other advanced synthetic fabrics can be used as outer layers alone or in combination with an inner liner. These materials help to create a barrier against the elements, preventing cold wind and moisture from penetrating.

Other suitable materials include merino wool, as it has excellent moisture-wicking properties, keeping the inner ear dry and maintaining warmth. Merino wool is also known for its ability to regulate body temperature, making it suitable for various cold weather activities. Fleece and faux fur may be utilized, wherein fleece can provide insulation and is lightweight, while faux fur adds extra warmth. Materials like nylon, Polytex® and polyester can be used for outer liner material, as they are durable, water-resistant, and can withstand harsh conditions. These materials may contribute to the overall functionality and durability of the ear cover 803. In all embodiments, additional protection from the weather can be realized by providing taped seams where the ear protector attaches to the bridle, halter, face mask, etc.

Still referring to FIG. 7, in this embodiment, the ear cover 803 is reversibly attachable to the main mask body 801 by way of connector 804. In this embodiment, a hook-and-loop fastening system is utilized, wherein a layer of the ‘hook’ material is sewn or otherwise attached to the main mask body 801, and a layer of the ‘loop’ material is sewn or otherwise attached to the ear cover 803. In this way, the ear cover 803 can be attached or detached as desired. It should be understood that other attachment mechanisms can be utilized, such as through the use of zippers, buttons, hooks, snaps and other means.

In this and other embodiments, the materials used for the ear covers 803 can extend to other areas of the face mask 800. For example, portions of the main mask body 801 can include one or more liners, each liner being composed of fleece, Gore-Tex®, nylon, mesh or other materials as prudent for the environmental conditions of the horse or other animal. As animal owners will recognize, portions of the main mask body 801, such as the portions that fit around the eyes of the animal can remain open or be outfitted with a thin mesh material so that the animal can see clearly from the face mask 800.

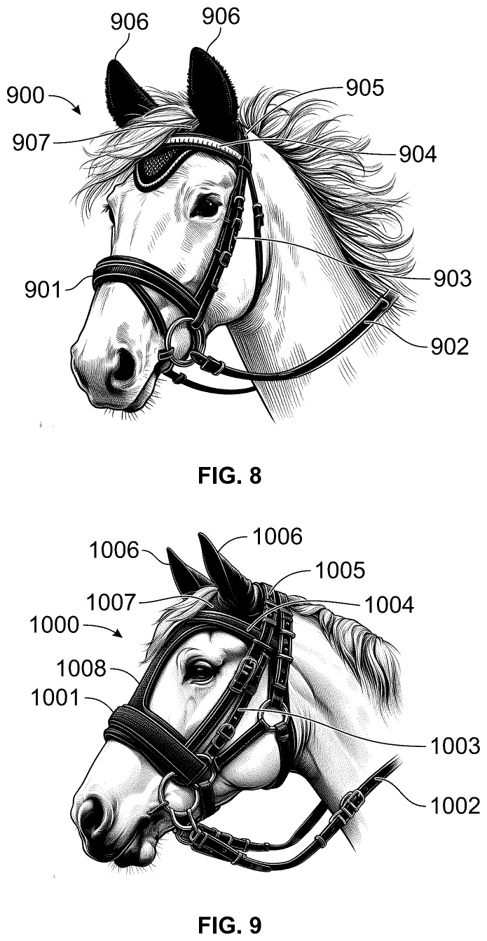

Turning now to FIG. 8 ear covers of the type described herein can be incorporated into various equestrian equipment such as, and without limitation, bridles and halters. For example, FIG. 8 illustrates a bridle system 900 including a noseband 901, reins 902, cheekpiece 903, browband 904, headpiece 905 and ear protectors 906. In this embodiment, the ear protectors 906 are attached between the browband 904 and headpiece 905. The ear protectors 906 in this embodiment can be connected by a shared flap 907, enabling both of the ear protectors and flap 907 to be installed into the bridle or removed as a single piece, as desired. Alternatively, each ear protector 906 may be individually removable through the use of hook-and-loop fasteners, zippers or other connection methods.

FIG. 9 shows an exemplary bridle system 1000 that is more rugged that the embodiment of FIG. 8 and includes a noseband 1001, reins 1002, cheekpiece 1003, browband 1004, headpiece 1005 and ear protectors 1006. Like the embodiment of FIG. 8, in this example, the ear protectors 1006 are attached between the browband 1004 and headpiece 1005. Similarly, the ear protectors 1006 in this embodiment can be connected by a shared flap 1007, enabling both of the ear protectors and flap 1007 to be installed into the bridle or removed as a single piece, as desired. Alternatively, each ear protector 1006 may be individually removable through the use of hook-and-loop fasteners, zippers or other connection methods. In this embodiment, the ear protectors 1006 have an outer layer formed of leather that matches the other bridle components, offering a stylish appearance but providing protection of the ears from wind, sound, cold and other environmental elements. In this embodiment, the bridle further includes a bridge piece 1008 that is sometimes used to provide additional protection to the horse. In such an embodiment, the bridge piece 1008 can additionally include materials to provide warmth and additional protection for the horse.

In one alternative embodiment, the protective mask includes one or more ventilation apertures, integrated into the outer layer, the inner layer, or both, reducing the likelihood of moisture buildup under the mask which can contribute to skin irritation and infection. Such a ventilation system can utilize aerodynamic designs and breathable materials, allowing for efficient air circulation while preventing the entry of pests and particulate matter. Such innovation can be particularly beneficial for maintaining an optimal body and skin temperature which can be vital for the animal's health and performance.

In this and other embodiments, the ornamental aspects of the masks can be customizable, providing visual and aesthetic features that cater to the preferences of animal owners and trainers, as well as functional visibility enhancements. Customization options include, e.g., a variety of colors, patterns, and designs that can reflect the animal's role, the owner's branding, or even the animal's personality. This customization extends to practical features such as reflective fabrics or LED lighting integration for enhanced visibility and safety in low-light conditions, further underscoring the mask's adaptability and utility in a broad range of scenarios, environments, and conditions.

In all embodiments, the mask is optimized for ease of maintenance and durability over time. The mask is formed of materials that are not only robust and protective but also easy to clean and maintain, with many components being machine washable or equipped with self-cleaning properties. Antimicrobial treatments and odor-resistant technologies can be applied to ensure that the mask remains hygienic and pleasant to use over extended periods, significantly reducing the time and resources required for maintenance.

In addressing the need for individualized protection based on specific health conditions or vulnerabilities, the mask includes options for medical-grade components. These components may include specialized inserts or linings that can release medication or therapeutic substances over time, offering continuous care for animals with chronic conditions or injuries. Such a feature integrates seamlessly with the mask's overall design, ensuring that animals receive not just physical protection but also ongoing health support.

In this and other embodiments, the mask is configured to incorporate modular components that can be easily added, removed, or replaced, depending on the specific requirements of the situation, recognizing the diverse environments and activities that animals are involved in. This modularity extends to protection against water, with waterproof yet breathable layers available for animals involved in aquatic activities or exposed to wet or rainy climates. Such versatility ensures that whether the animal is engaged in competitive sports, working in rugged terrains, or simply enjoying outdoor activities, the mask can be adapted to provide optimal protection and comfort.

In this and other embodiments, the protective mask prioritizes durability, performance, and longevity, incorporating high-quality materials and expert craftsmanship. Advanced techniques such as secure stitching, heat sealing, ultrasonic welding, adhesive bonding, or 3D printing can be employed to enhance durability, waterproofing, or customization, ensuring the mask withstands the rigors of daily use and outdoor activities, especially for the case of horses who are frequently turned out to pasture. Reinforced stitching, double-layered materials, or impact-resistant coatings further enhance the mask's durability and performance in rugged environments, providing reliable protection and peace of mind to animal owners and caretakers.

In operation, the protective mask offers comprehensive protection against a myriad of environmental factors, including insects, dust, debris, UV radiation, wind, rain, snow, extreme temperatures, sound and physical abrasions. The versatile design and customizable features of the mask make it suitable for a wide range of animals, meeting the diverse needs and expectations of animal owners, veterinarians, trainers, and caregivers. Beyond its primary application in care and management, the mask's versatility extends to various activities such as equestrian sports, recreational riding, therapy programs, agricultural work, and pet care, underscoring its practical utility and market appeal.

A number of illustrative embodiments have been described. Nevertheless, it will be understood that various modifications may be made without departing from the spirit and scope of the various embodiments presented herein. In particular, the masks described herein can be extended to riding masks, bonnets and other equestrian wear, with varied types of insulation and weather-protective materials for the face, ears, and nose, providing a wide selection of products supporting the health and well-being of animals in varied climate conditions. The masks can be suitable for unsupervised turnout to pasture for horses, in particular. In some embodiments, the masks can include detachable nose coverings, or an integrated nose covering. In some embodiments, the masks can include detachable neck coverings, or an integrated neck covering. In all embodiments, the mask and its accessories, if included, can be fully adjustable to the anatomy of the animal. The features described herein can be extended to any type of halter, bridle, mask, bonnet or other animal accessory. Accordingly, other embodiments are within the scope of the following claims.

What is claimed is:

1. A multi layered animal mask comprising an outer layer placed around a face and head of an animal,
an insulated inner layer mounted inside of the outer layer for providing insulation to the animal's face and head, and
ear coverings on the mask in alignment with the animal's ears.

2. The animal mask of claim 1 and further comprising an insulated layer mounted inside of the ear coverings.

3. Claim 1 wherein the insulated inner layer is removable and interchangeable.

4. The animal mask of claim 1 wherein the ear coverings are removably attached to the mask.

5. The animal mask of claim 1 wherein the mask has a proximal end placed over the animal's nose and a distal end placed over the animal's head and behind the ears.

6. The animal mask of claim 1 wherein the inner layer is selected from the group consisting of wool, fleece, neoprene, cotton, synthetic fibers, polar fleece, faux fur, Thinsulate, neoprene, ceramic Infused materials, ultraviolet shielding, waterproof nylon, leather, rubber, mesh fabrics, bamboo fibers, polytetrafluoroethylene, down feather fill, polyether-polyurea copolymer, and thermal latex.

7. The animal mask of claim 1 and further comprising a reflective material on the mask.

8. The animal mask of claim 1 wherein the mask is divided in half from the proximal end to the distal end to permit placing the mask over the animal's face and head and further comprising fasteners to secure the mask around the animal's face and head once it is placed over the animal's face and head.

9. The mask on claim 1 wherein the mask is of one piece so that it is slid over the animals face and head from the animal's nose to the neck.

10. The animal mask of claim 1 and further comprising openings in the mask aligned with the animal's eyes.

11. The animal mask of claim 1 wherein the outer layer is an ultraviolet protective layer.

12. The animal mask of claim 1 wherein the outer layer is a water resistance layer.

13. The animal mask of claim 1 and further comprising an opening between the ear coverings to accommodate the animal's forelock.

14. The animal mask of claim 1 and further comprising a removable neck cover removable attached to the distal end of the mask.

15. The animal mask of claim 1 wherein the inner layer contains a medical preparation.

16. The animal mask of claim 1 and further comprising a halter affixed to the mask.

17. A multi layered animal mask comprising a proximal end and a distal end, the proximal end having a nose portion mounted over the animals nose and face and a distal end having an ear portion mounted over the animals ears;
the ear portion having two ear pieces aligned with the animal's ears and adapted to receive the animal's ears;
the nose portion having a protective outer layer; and
an insulated layer mounted inside the nose portion between the animal's nose and the protective outer layer.

18. The animal mask of claim 17 wherein the insulated inner layer is removable and interchangeable.

19. The animal mask of claim 17 wherein the ear portion is selected of materials from the group consisting of ultraviolet materials, waterproof materials, and water resistant materials.

20. The animal mask of claim 17 and further comprising an insulated layer mounted inside of the ear pieces.

21. The animal mask of claim 17 wherein the interchangeable insulated layer is selected from the group consisting of wool, fleece, neoprene, cotton, synthetic fibers, polar fleece, faux fur, Thinsulate, neoprene, ceramic Infused materials, ultraviolet shielding, waterproof nylon, leather, rubber, mesh fabrics, bamboo fibers, polytetrafluoroethylene, down feather fill, polyether-polyurea copolymer, and thermal latex.

22. The animal mask of claim 16 and further comprising a reflective material on the mask.

23. The animal mask of claim 16 wherein the ear coverings are removably attached to the mask.

24. The animal mask of claim 16 and further comprising a removable neck cover removable attached to the distal end of the mask.

25. The animal mask of claim 16 wherein the mask is divided in half from the proximal end to the distal end to permit placing the mask over the animal's head and further comprising fasteners to secure the mask around the animal's head once it is placed over the animal's head.

26. The animal mask of claim 16 and further comprising a halter affixed to the mask.
